(19) United States
(12) Patent Application Publication
(10) Pub. No.: US 2017/0012347 A1
(43) Pub. Date: Jan. 12, 2017

(54) WIRELESS DEVICE

(71) Applicant: SHARP KABUSHIKI KAISHA, Sakai City (JP)

(72) Inventors: Shuhei OHGUCHI, Sakai-shi (JP); Hiroyuki TAKEBE, Sakai-shi (JP)

(21) Appl. No.: 15/119,137

(22) PCT Filed: Dec. 10, 2014
(86) PCT No.: PCT/JP2014/082672

§ 371 Date: Aug. 16, 2016

(30) Foreign Application Priority Data
Feb. 19, 2014 (JP) 2014-030048

(51) Int. Cl. H01Q 1/24; H01Q 9/42; H01Q 1/50

(52) U.S. Cl. CPC H01Q 1/243; H01Q 1/50; H01Q 9/42

(57) ABSTRACT

A degree of freedom in design of a frame member that serves as an antenna is improved without causing a decrease in antenna characteristics. A frame member (1) has a first reference electric potential connection point (6a) and a second reference electric potential connection point (6b), each of which is connected to a reference electric potential (G) of a housing. A wireless circuit (2) is connected to a feed connection point (4) located between the first and second reference electric potential connection points (6a and 6b) of the frame member (1).

### TECHNICAL FIELD

The present invention relates to a wireless device whose frame member, made of an electrical conductor and provided along a periphery of a housing of the wireless device, is caused to serve as an antenna.

### BACKGROUND ART

There has been conventionally known a wireless device in which a metal frame, provided along a periphery of a housing of the wireless device, is caused to serves as an antenna.

For example, Patent Literature 1 discloses a wireless mobile device including a first metal frame and a second metal frame. The first metal frame, having a length substantially half of that of a periphery of a housing, is provided along an upper part of an outer surface of the housing. The second metal frame, having a length substantially half of that of the periphery of the housing, is provided along a lower part of the outer surface of the housing. One end of the first metal frame is connected to a feed terminal that is connected to a matching circuit provided on a circuit board. The other end of the first metal frame is connected to a ground of the circuit board via a first ground terminal. One end of the second metal frame is connected, in the vicinity of the feed terminal, to the ground of the circuit board via a second ground terminal. The other end of the second metal frame is located, as an open end, near the first ground terminal. The first and second metal frames have substantially identical electrical lengths.

### CITATION LIST

### Patent Literature

[Patent Literature 1]

Japanese Patent Application Publication Tokukai No. 2012-235258 (Publication date: Nov. 29, 2012)

### SUMMARY OF INVENTION

### Technical Problem

However, in order to secure antenna characteristics in the technique disclosed in Patent Literature 1, it is necessary that a length of the first and second metal frames be set to a length corresponding to a wavelength of a frequency that is to be used during communications. This causes a problem that a degree of freedom is low in design of the metal frames.

The present invention has been made in view of the above problem. An object of the present invention is to increase a degree of freedom of a frame member that is caused to serve as an antenna, without deteriorating an antenna characteristic.

### Solution to Problem

In order to attain the above object, a wireless device according to an aspect of the present invention includes: a frame member that is electrically conductive and is provided along a periphery of a housing; and a wireless circuit that makes a wireless communication by using the frame member as an antenna, the frame member having (i) a first reference electric potential connection point and (ii) a second reference electric potential connection point, each of which is connected to a reference electric potential of the housing, the wireless circuit being connected to a feed connection point that is located between the first reference electric potential connection point and the second reference electric potential connection point.

### Advantageous Effects of Invention

With the above configuration, a region, on the frame member, between the first and second reference electric potential connection points serves as an antenna, and an outside of this region on the frame member scarcely affects an antenna characteristic. That is, regardless of how (i) a divided position of the frame member is set, (ii) the divided number of the frame member is set, (iii) a length of the frame member is set, (iv) a width of the frame member is set, or the like, the antenna characteristic does not decrease, as long as such settings are made, on the frame member, outside the above region. This makes it possible to increase a degree of freedom in design of the frame member that is caused to serve as an antenna, without decreasing the antenna characteristic.

### BRIEF DESCRIPTION OF DRAWINGS

FIG. 1 illustrates a schematic configuration of a wireless device in accordance with Embodiment 1 of the present invention.

(a) and (b) of FIG. 2 each illustrate a variation of the wireless device illustrated in FIG. 1.

(a) and (b) of FIG. 3 each illustrate a variation of the wireless device illustrated in FIG. 1.

(a) and (b) of FIG. 4 each illustrate a schematic configuration of a wireless device in accordance with Embodiment 2 of the present invention.

FIG. 5 illustrates a variation of the wireless device illustrated in FIG. 4.

FIG. 6 illustrates a schematic configuration of a wireless device in accordance with Embodiment 3 of the present invention.

FIG. 7 illustrates a schematic configuration of a wireless device in accordance with Embodiment 4 of the present invention.

FIG. 8 illustrates a schematic configuration of a wireless device in accordance with Embodiment 5 of the present invention.

FIG. 9 illustrates a variation of the wireless device illustrated in FIG. 8.

FIG. 10 illustrates a schematic configuration of a wireless device in accordance with Embodiment 6 of the present invention.

FIG. 11 illustrates a schematic configuration of a wireless device in accordance with Embodiment 7 of the present invention.

### DESCRIPTION OF EMBODIMENTS

### Embodiment 1

The following description will discuss Embodiment 1 of the present invention.

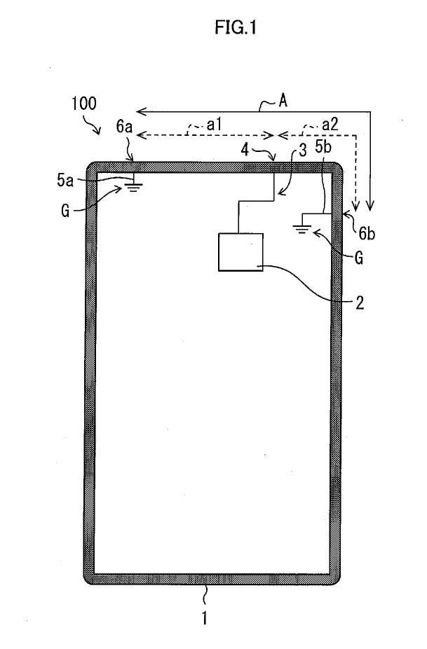

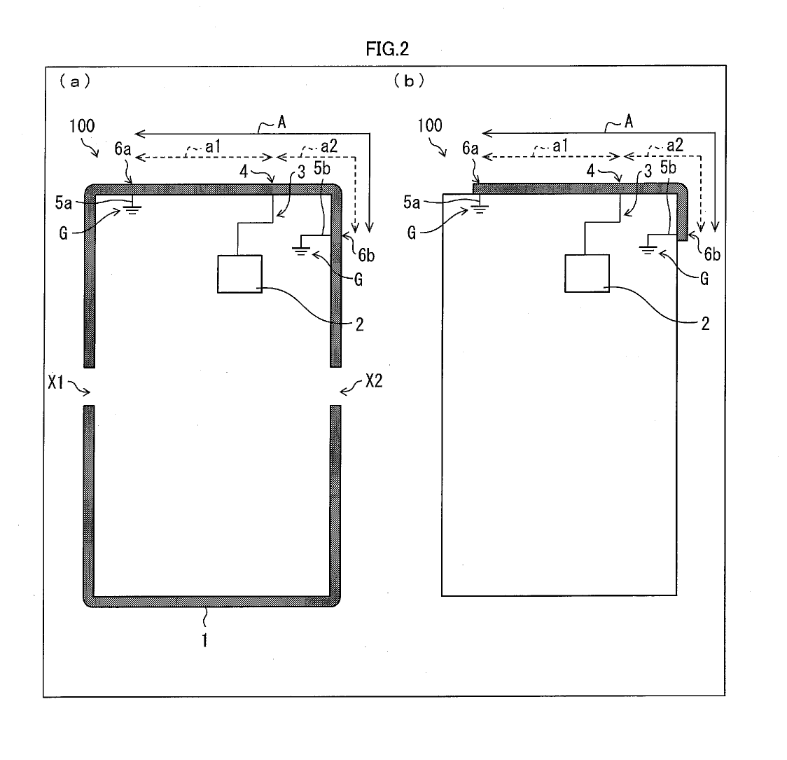

FIG. 1 illustrates a schematic configuration of a wireless device 100 in accordance with Embodiment 1. As illustrated in FIG. 1, the wireless device 100, having a frame member (electrically conductive frame member) 1 and a wireless circuit 2, is connected to a reference electric potential G.

The frame member 1, made of an electrical conductor, is provided along a periphery of a housing of the wireless device 100, and serves as an antenna of the wireless device 100. A material of the frame member 1 is not particularly limited, provided that it is a material having an electrically conductivity. For example, it is possible to employ metal as a material of the frame member 1. The frame member 1 can be configured so as to be visible from outside the wireless device 100 or can alternatively be configured so as to be invisible from outside the wireless device 100 (e.g., the frame member 1 can be covered with a resin). The frame member 1 is not particularly limited in width and thickness. The width and thickness of the frame member 1 can vary from position to position (i.e., the width and the thickness are not necessarily constant).

The wireless circuit 2 is connected to a feed connection point 4 of the frame member 1 via a feed connector 3, and makes a wireless communication with other devices by using the frame member 1 as an antenna. The wireless circuit 2 is not particularly limited in configuration, and any conventional wireless circuit can be employed as the wireless circuit 2. The feed connector 3 is also not particularly limited in configuration, provided that it can cause the wireless circuit 2 and the frame member 1 to be electrically conductive.

The reference electric potential G causes each section of the wireless device 100a to have the reference electric potential (ground electric potential or constant electric potential), and is connected to the housing of the wireless device 100. The reference electric potential G is not particularly limited. For example, a metal member for reinforcing a display device (e.g., liquid crystal display device) of the wireless device 100 or a ground terminal of a substrate can serve as the reference electric potential G.

In Embodiment 1, a reference electric potential connection point (first reference electric potential connection point) 6a and a reference electric potential connection point (second reference electric potential connection point) 6b of the frame member 1 are connected to the reference electric potential G, via respective reference electric potential connectors 5a and 5b (see FIG. 1). As illustrated in FIG. 1, the reference electric potential connection points 6a and 6b are located on sides different with respect to the feed connection point 4. That is, the feed connection point 4 is located, on the frame member 1, between the reference electric potential connection points 6a and 6b.

Note that the reference electric potential connectors 5a and 5b are not particularly limited in configuration, provided that they allow the frame member 1 and the reference electric potential to be electrically conductive.

Note also that how the reference electric potential connectors 5a and 5b and the feed connector 3 are connected to the frame member 1 is not limited to a particular method. For example, fastening with screws, soldering, or welding can be employed. Each of the reference electric potential connectors 5a and 5b and the feed connector 3 can be partially or entirely connected to the frame member 1, via a member such as a stainless steel member or a flexible wiring pattern.

As described above, according to the wireless device 100 in accordance with Embodiment 1, the reference electric potential connection points 6a and 6b are each connected to the reference electric potential G, and the feed connection point 4, which is located between the reference electric potential connection points 6a and 6b of the frame member 1, is connected to the wireless circuit 2.

With the above configuration, an electrical length between the reference electric potential connection points 6a and 6b of the frame member 1 (i.e., an electrical length determined depending on the width and thickness of the frame member 1 and a dielectric constant etc. of peripheral members of the frame member 1) resonates at a frequency corresponding to λ/2 (λ: wavelength). It follows that an excellent antenna characteristic can be obtained by setting, in accordance with the frequency to be used during communication, positions of (i.e., a spacing between) the respective reference electric potential connection points 6a and 6b. Note that a resonance frequency can be adjusted, for example, by changing a position of the feed connection point 4 and/or by use of antenna constant matching sections 7 and 8 (later described).

Current distributions occur in (i) a region (see a region a1 indicated by a dotted line in FIG. 1) between the reference electric potential connection point 6a and the feed connection point 4 and (ii) a region (see a region a2 indicated by a dotted line in FIG. 1) between the feed connection point 4 and the reference electric potential connection point 6b. The two regions (see a region A indicated by a solid line in FIG. 1) serve as an antenna. It follows that an outside of the two regions of the frame member 1 (i.e., a region other than the region between the reference electric potential connection points 6a and 6b) scarcely contributes to an antenna characteristic. That is, the frame member 1 needs only to be located in a region between the reference electric potential connection points 6a and 6b. Regardless of how (i) a divided position of the frame member 1 is set, (ii) the divided number of the frame member 1 is set, (iii) a length of the frame member 1 is set, (iv) a width of the frame member 1 is set, or the like, the antenna characteristic is scarcely affected, as long as such settings are made outside the region between the reference electric potential connection points 6a and 6b.

The antenna characteristic thus does not decrease even in a case where, for example, (i) the frame member 1 is divided at given positions (split positions X1 and X2) outside the region between the reference electric potential connection points 6a and 6b (see (a) of FIG. 2) or (ii) the frame member 1 is provided only between the reference electric potential connection point 6a and 6b (see (b) of FIG. 2).

The wireless device 100 in accordance with Embodiment 1 therefore makes it possible to increase a degree of freedom in design of the frame member 1, without decreasing the antenna characteristic.

Note that, in Embodiment 1, the frame member 1 is connected to the reference electric potential G at two positions. Embodiment 1 is, however, not limited as such. It is only necessary that the frame member 1 be connected to the reference electric potential G at two or more positions. Alternatively, the frame member 1 can be connected to the reference electric potential G at three positions or more.

Note also that, according to the configuration illustrated in FIG. 1, the wireless circuit 2 is directly connected to the frame member 1 via the feed connector 3, but is not limited as such. Alternatively, the wireless circuit 2 can be connected to the frame member 1 via, for example, an antenna constant matching section 7 (see (a) of FIG. 3).

The antenna constant matching section 7 is a member that is inserted into the feed connector 3 so as to match an impedance (matching constant) of an antenna with a frequency to be used. It is possible to employ, as the antenna constant matching section 7, for example, an inductor, a capacitor, a switch (e.g., a diode for switching the matching constant), or a filter (e.g., a bandpass filter for filtering only a signal having a specific frequency band).

The provision of the antenna constant matching section 7 makes it possible to change a resonance frequency of the frame member 1. That is, it is possible to change a length, between the reference electric potential connection points 6a and 6b, which resonates at a frequency to be used during communications. This makes it possible to further increase the degree of freedom in design of the frame member 1.

In addition to the antenna constant matching section 7, it is also possible to further provide an antenna constant matching section 8 in the reference electric potential connector 5a (see (b) of FIG. 3). The antenna constant matching section 8 is a member that is inserted into the reference electric potential connector 5a so as to match an impedance (matching constant) of an antenna with a frequency to be used. It is possible to employ, as the antenna constant matching section 8, for example, an inductor or a capacitor.

Note that the antenna constant matching section 8 can be provided without the antenna constant matching section 7. Alternatively, the reference electric potential connector 5b can include another antenna constant matching section (not illustrated), (i) in addition to the antenna constant matching sections 7 and 8 or (ii) instead of both or one of the antenna constant matching sections 7 and 8.

### Embodiment 2

The following description will discuss Embodiment 2 of the present invention. For convenience, any member having a function identical to that of a member discussed in Embodiment 1 will be given an identical reference numeral, and a description thereof will be omitted.

FIG. 4 illustrates a schematic configuration of a wireless device 100 in accordance with Embodiment 2. As illustrated in FIG. 4, the wireless device 100 in accordance with Embodiment 2 further includes, in addition to the configuration illustrated in FIG. 1, a reference electric potential connector 5c.

The reference electric potential connector 5c connects, to a reference electric potential G, a reference electric potential connection point (third reference electric potential connection point) 6c, which is a part of a frame member 1. The reference electric potential connection point 6c is located between a reference electric potential connection point 6a and a feed connection point 4 of the frame member 1. How the reference electric potential connector 5c is connected to the frame member 1 is not limited to a particular method. For example, the reference electric potential connector 5c can be connected to the frame member 1 in a manner similar to the reference electric potential connectors 5a and 5b.

The reference electric potential connector 5c includes a switch S1 that can switch, in response to an instruction from a wireless circuit 2, between an open state (see (a) of FIG. 4) and a closed state (see (b) of FIG. 4). Note that the switch S1 can alternatively be configured such that a user manually switches the switch S1. The switch S1 is not particularly limited in configuration, provided that it can switch states between the frame member 1 and the reference electric potential G, i.e., from a closed state (conductive state) to a closed state (blocking state) or vice versa. For example, a single-pole single-throw (SPST) switch can be employed as the switch S1.

In a case where the switch S1 is in an open state (see (a) of FIG. 4), as with the case of FIG. 1, current distributions occur in (i) a region (see a region a1 indicated by a dotted line in (a) of FIG. 4) between the reference electric potential connection point 6a and the feed connection point 4 and (ii) a region (see a region a2 indicated by a dotted line in (a) of FIG. 4) between the feed connection point 4 and the reference electric potential connection point 6b. The two regions (see a region A indicated by a solid line in (a) of FIG. 4) serve as an antenna.

In a case where the switch S1 is in a closed state (see (b) of FIG. 4), current distributions occur in (i) a region (see a region b1 indicated by a dotted line in (b) of FIG. 4) between the reference electric potential connection point 6c and the feed connection point 4 and (ii) a region (see the region a2 indicated by a dotted line in (b) of FIG. 4) between the feed connection point 4 and the reference electric potential connection point 6b. The two regions (see a region B indicated by a solid line in (b) of FIG. 4) serve as an antenna.

As described above, the wireless device 100 in accordance with Embodiment 2 can change a resonance frequency of the frame member 1, by switching a connection position at which the frame member 1 is connected to the reference electric potential G. This makes it possible to make communications with the use of various frequencies.

Note that in Embodiment 2, the reference electric potential connection point 6c is located, on the frame member 1, between the reference electric potential connection point 6a and the feed connection point 4, but is not limited as such. For example, the reference electric potential connection point 6c can also be located, on the frame member 1, between the feed connection point 4 and the reference electric potential connection point 6b.

Alternatively, the frame member 1 can be connected, via switches, to the reference electric potential G at a plurality of positions between the reference electric potential connection points 6a and 6b. In such a case, switches similar to the switch S1 can be employed as the respective switches.

For example, (i) the reference electric potential connector 5c can be located, on the frame member 1, between the reference electric potential connection point 6a and the feed connection point 4, and (ii) another reference electric potential connection point (not illustrated) can be located, on the frame member 1, between the feed connection point 4 and the reference electric potential connection point 6b. The another reference electric potential connection point can be connected to the reference electric potential G via a switch (not illustrated). Alternatively, a plurality of reference electric potential connection points (not illustrated) can be located (i) between the reference electric potential connection point 6a and the feed connection point 4 and/or (ii) between the feed connection point 4 and the reference electric potential connection point 6b. The plurality of reference electric potential connection points can be connected to the reference electric potential G via respective switches (not illustrated).

With such a configuration, it is possible to make communications with use of a greater variety of frequencies, by controlling a combination of open and close states of the respective switches.

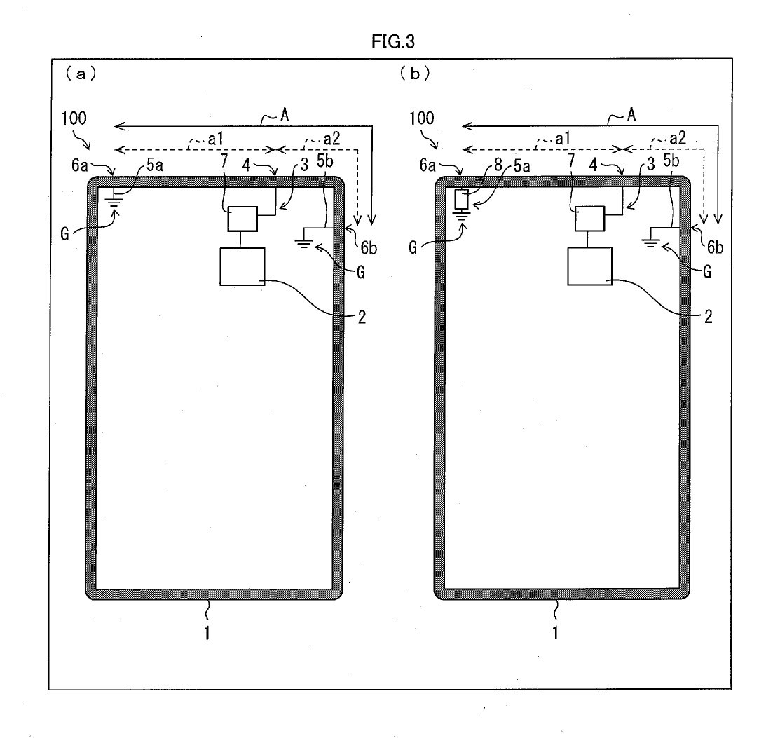

Note that as illustrated in FIG. 5, it is also possible to change a matching constant by (i) providing, as a switch S2, a single-pole double-throw (SPDT) switch in the reference electric potential connector 5a and (ii) switching a connection path that connects the frame member 1 to the reference electric potential G.

In an example illustrated in FIG. 5, (i) a single-pole part of the switch S2 is connected to the reference electric potential connection point 6a of the frame member 1, (ii) one of double-through parts of the switch S2 is connected to the reference electric potential G via an antenna constant matching section 9a, and (iii) the other one of double-through parts of the switch S2 is connected to the reference electric potential G via an antenna constant matching section 9b. The antenna constant matching sections 9a and 9b are achieved by, for example, an inductor, a capacitor, a jumper resistor (0Ω resistor), or a copper foil pattern, and have different impedance characteristics (i.e., the antenna constant matching sections 9a and 9b are configured to realize respective different matching constants).

The switch S2 is switched by the wireless circuit 2. The wireless circuit 2 controls the switch S2 in accordance with a frequency to be used during communications so that the switch S2 is switched between (i) a state where the reference electric potential connection point 6a is connected to the reference electric potential G via the antenna constant matching section 9a and (ii) a state where the reference electric potential connection point 6a is connected to the reference electric potential G via the antenna constant matching section 9b. This makes it possible to make communications with the use of various frequencies.

FIG. 5 illustrates a configuration in which two connection paths, each of which connects the reference electric potential connector 5a to the reference electric potential G, are switched. Note, however, that Embodiment 2 is not limited as such. Specifically, Embodiment 2 can include alternative configurations in which three or more connection paths can be switched.

A switch S2 can be alternatively configured to be provided in the reference electric potential connector 5b, in addition to or instead of the reference electric potential connector 5a. With the configuration, two or more connection paths, which (i) have respective different characteristics and (ii) are provided between the reference electric potential connection point 6b and the reference electric potential G, can be switched. It is therefore possible to make diverse communications by switching, in accordance with a frequency to be used during a corresponding communication, connection paths that connect, at respective reference electric potential connectors, the frame member 1 and the reference electric potential G.

Note that in Embodiment 2, as with Embodiment 1, regardless of how (i) a divided position of the frame member 1 is set, (ii) the divided number of the frame member 1 is set, (iii) a length of the frame member 1 is set, (iv) a width of the frame member 1 is set, or the like, the antenna characteristic is scarcely affected, as long as such settings are made, on the frame member 1, outside a region between the reference electric potential connection points 6a and 6b. This makes it possible to increase, as with Embodiment 1, a degree of freedom in design of the frame member 1, without decreasing the antenna characteristic.

### Embodiment 3

The following description will discuss Embodiment 3 of the present invention. For convenience, any member having a function identical to that of a member discussed in the foregoing embodiments will be given an identical reference numeral, and a description thereof will be omitted.

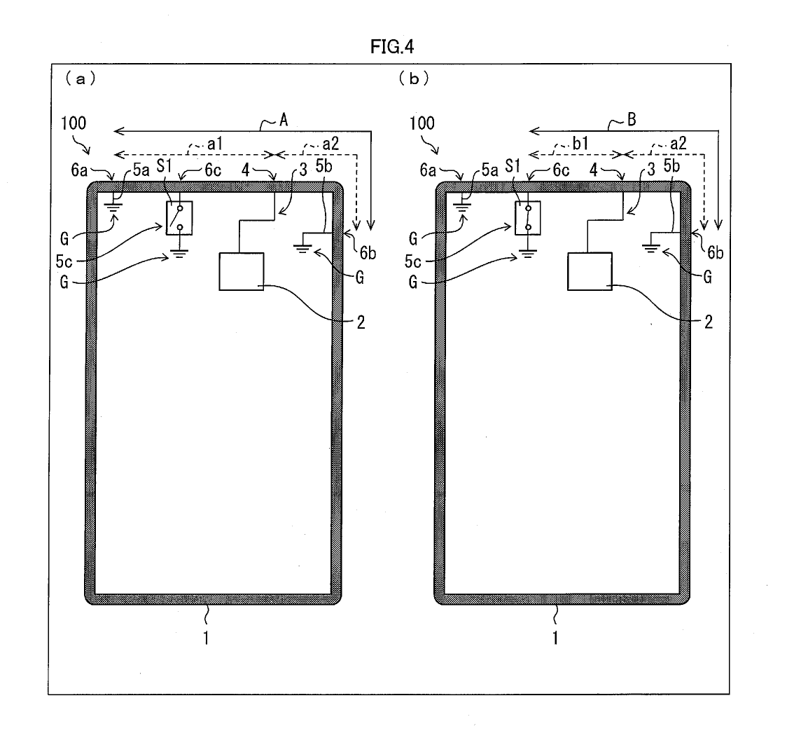

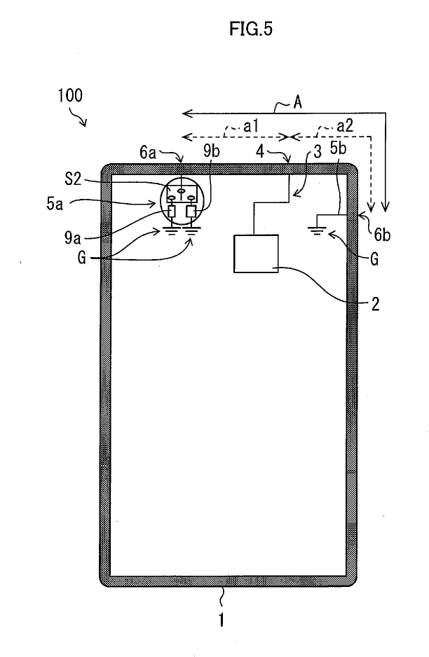

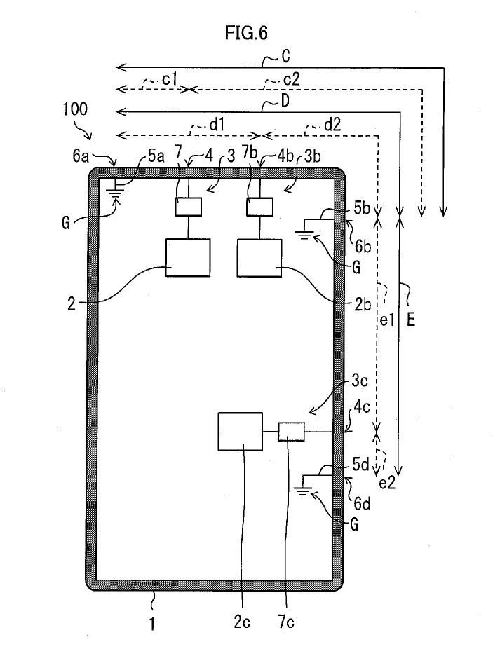

FIG. 6 illustrates a schematic configuration of a wireless device 100 in accordance with Embodiment 3. As illustrated in FIG. 6, the wireless device 100 in accordance with Embodiment 3 further includes, in addition to the configuration illustrated in FIG. 1, (i) a wireless circuit 2b, (ii) a wireless circuit 2c, and (iii) a reference electric potential connector 5d. The wireless circuit 2b is connected to a feed connection point 4b of a frame member 1 via a feed connector 3b that includes an antenna constant matching section 7b. The wireless circuit 2c is connected to a feed connection point 4c of the frame member 1 via a feed connector 3c that includes an antenna constant matching section 7c. The reference electric potential connector 5d connects a reference electric potential connection point (fourth reference electric potential connection point) 6d of the frame member 1 to a reference electric potential G. Note that (i) the feed connection point 4b is located between the feed connection point 4 and the reference electric potential connection point 6b, and (ii) the feed connection point 4c is located between the reference electric potential connection points 6b and 6d.

The wireless circuits 2b and 2c make communications with other devices by using the frame member 1 as an antenna. Note that the wireless circuits 2, 2b, and 2c can make wireless communications via identical systems (i.e., with use of identical frequencies). The wireless circuits 2, 2b, and 2c can alternatively make wireless communications via respective different systems (i.e., with use of respective different frequencies). Resonance frequencies of antennas used by the respective wireless circuits 2 and 2b can be adjusted to different frequencies by adjusting, for example, positions of the respective feed connection points 4 and 4b and positions of the respective antenna constant matching sections 7 and 7b. Examples of cases where different systems are employed encompass (i) a system in which the frame member 1 serves as an antenna for global positioning system (GPS) communications and (ii) a system in which the frame member 1 serves as an antenna for Wi-Fi (registered trademark) communications.

Note that FIG. 6 illustrates a configuration in which the antenna constant matching sections 7, 7b, and 7c are provided between the frame member 1 and the wireless circuits 2, 2b, and 2c, respectively. Note, however, that the antenna constant matching sections 7, 7b, and 7c are not essential, and a part of or all of them can therefore be omitted.

With the above configuration, in a case where the wireless circuit 2 makes a communication, as illustrated in FIG. 6, current distributions occur in (i) a region (see a region c1 indicated by a dotted line in FIG. 6) between the reference electric potential connection point 6a and the feed connection point 4 and (ii) a region (see a region c2 indicated by a dotted line in FIG. 6) between the feed connection point 4 and the reference electric potential connection point 6b. The two regions (see a region C indicated by a solid line in FIG. 6) serve as an antenna.

Alternatively, in a case where the wireless circuit 2b makes a communication, as illustrated in FIG. 6, current distributions occur in (i) a region (see a region d1 indicated by a dotted line in FIG. 6) between the reference electric potential connection point 6a and the feed connection point 4b and (ii) a region (see a region d2 indicated by a dotted line in FIG. 6) between the feed connection point 4b and the reference electric potential connection point 6b. The two regions (see a region D indicated by a solid line in FIG. 6) serve as an antenna.

Further alternatively, in a case where the wireless circuit 2c makes a communication, as illustrated in FIG. 6, current distributions occur in (i) a region (see a region e1 indicated by a dotted line in FIG. 6) between the reference electric potential connection point 6b and the feed connection point 4c and (ii) a region (see a region e2 indicated by a dotted line in FIG. 6) between the feed connection point 4c and the reference electric potential connection point 6d. The two regions (see a region E indicated by a solid line in FIG. 6) serve as an antenna.

It is therefore possible to make communications via various systems (i.e., with use of various frequencies).

Note that, as with Embodiment 1, regardless of how (i) a divided position of the frame member 1 is set, (ii) the divided number of the frame member 1 is set, (iii) a length of the frame member 1 is set, (iv) a width of the frame member 1 is set, or the like, the antenna characteristic is scarcely affected, as long as such settings are made, on the frame member 1, outside a region between the reference electric potential connection points 6a and 6d. This makes it possible to increase a degree of freedom in design of the frame member 1, without decreasing the antenna characteristic.

### Embodiment 4

The following description will discuss Embodiment 4 of the present invention. For convenience, any member having a function identical to that of a member discussed in the foregoing embodiments will be given an identical reference numeral, and a description thereof will be omitted.

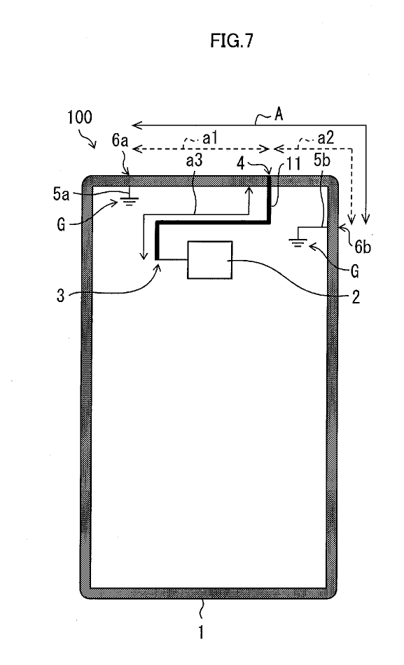

FIG. 7 illustrates a schematic configuration of a wireless device 100 in accordance with Embodiment 4. As illustrated in FIG. 7, the wireless device 100 in accordance with Embodiment 4 further includes, in addition to the configuration illustrated in FIG. 1, an antenna member (antenna element) 11, which serves as an antenna and is provided at an end, of a feed connector 3, on a side of a feed connection point 4. A wireless circuit 2 is connected to a frame member 1 via the antenna member 11.

Examples of the member that can be employed as the antenna member 11 encompass: (i) a member, integrated with a cabinet, that is made of metal such as aluminum, stainless steel, or magnesium; (ii) a member, integrated with a cabinet (supporting member), such as a molded interconnect device (MID), a laser direct structuring (LDS), or a direct printed antenna (PDA); and (iii) a member patterned on a substrate.

Note that (i) the antenna member 11 can be provided separately from the frame member 1 and (ii) the antenna member 11 can alternatively be configured to be integrated with the frame member 1 (configured such that a part of the frame member 1 extends toward inside a housing).

The provision of the antenna member 11 allows an increase in the number of current paths that serve as antennas (see a region a3 indicated by a solid line in FIG. 7). This makes it possible to make communications with the use of various frequencies.

Note that, as with Embodiment 1, regardless of how (i) a divided position of the frame member 1 is set, (ii) the divided number of the frame member 1 is set, (iii) a length of the frame member 1 is set, (iv) a width of the frame member 1 is set, or the like, the antenna characteristic is scarcely affected, as long as such settings are made, on the frame member 1, outside a region between the reference electric potential connection points 6a and 6b. This makes it possible to increase a degree of freedom in design of the frame member 1, without decreasing the antenna characteristic.

### Embodiment 5

The following description will discuss Embodiment 5 of the present invention. For convenience, any member having a function identical to that of a member discussed in the foregoing embodiments will be given an identical reference numeral, and a description thereof will be omitted.

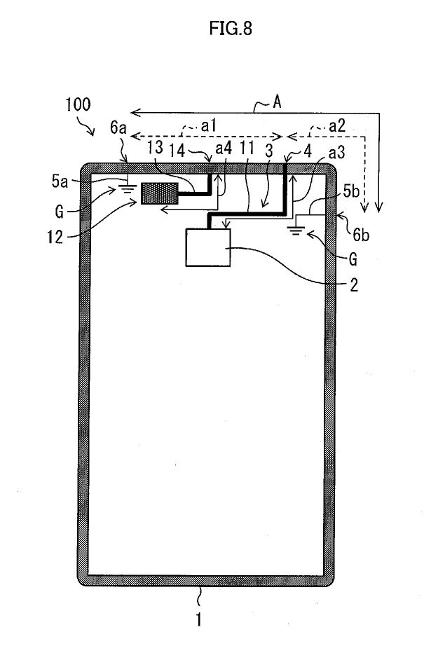

FIG. 8 illustrates a schematic configuration of a wireless device 100 in accordance with Embodiment 5. As illustrated in FIG. 8, the wireless device 100 in accordance with Embodiment 5 is configured such that (i) the entire part of a feed connector 3 is configured by an antenna member 11 and (ii) a capacitor element 12, which is connected to a capacitor connection point 14 of a frame member 1 via an antenna member 13, is provided. FIG. 8 illustrates a configuration in which the capacitor connection point 14 is provided between a reference electric potential connection point 6a and a feed connection point 4. Note, however, that Embodiment 5 is not limited as such. Alternatively, the capacitor connection point 14 can be provided between the feed connection point 4 and a reference electric potential connection point 6b.

A configuration similar to the antenna member 11 can be employed as the antenna member 13. The antenna member 13 can be provided separately from the frame member 1. The antenna member 13 can alternatively be configured to be integrated with the frame member 1 (configured such that a part of the frame member 1 extends toward inside a housing).

A member to be employed as the capacitor element 12 is not particularly limited in configuration. For example, a member integrated with the antenna member 13 can be employed as the capacitor element 12. Alternatively, a tip of the antenna member 13 (i.e., an end, of the antenna member 13, on a side opposite to the capacitor connection point 14) can be employed as the capacitor element 12.

The provision of the capacitor element 12, which is capacitive-coupled with the reference electric potential G, allows an increase in the number of current paths that serve as antennas (see an arrow a4 of FIG. 8). This makes it possible to make communications with the use of various frequencies.

Note that, as with Embodiment 1, regardless of how (i) a divided position of the frame member 1 is set, (ii) the divided number of the frame member 1 is set, (iii) a length of the frame member 1 is set, (iv) a width of the frame member 1 is set, or the like, the antenna characteristic is scarcely affected, as long as such settings are made, on the frame member 1, outside a region between the reference electric potential connection points 6a and 6b. This makes it possible to increase a degree of freedom in design of the frame member 1, without decreasing the antenna characteristic.

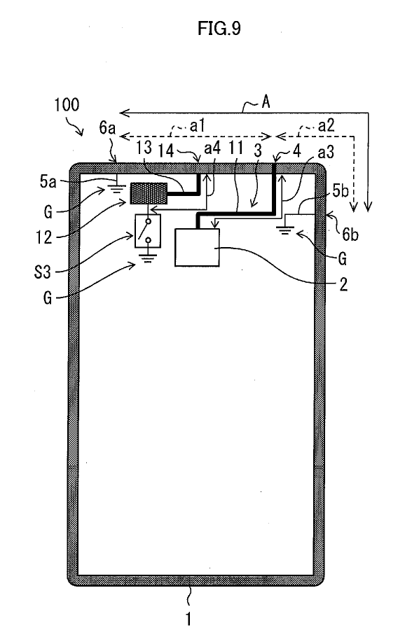

Note that the capacitor element 12 can be caused to serve as an open end of an antenna. An impedance of an antenna can be adjusted by adjusting a capacity between the capacitive element 12 and the reference electric potential G. Alternatively, it is also possible to provide, as illustrated in FIG. 9, a switch S3 between the capacitive element 12 and the reference electric potential G so that the wireless circuit 2 can switch, in accordance with a communication frequency, the switch S3 between an open state and a closed state. Note that the switch S3 can alternatively be manually switched by a user, instead of the wireless circuit 2 switching the switch S3.

### Embodiment 6

The following description will discuss Embodiment 6 of the present invention. For convenience, any member having a function identical to that of a member discussed in the foregoing embodiments will be given an identical reference numeral, and a description thereof will be omitted.

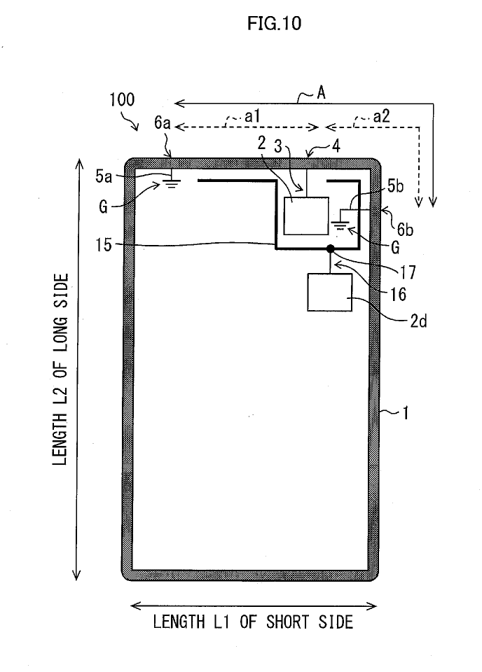

FIG. 10 illustrates a schematic configuration of a wireless device 100 in accordance with Embodiment 6. As illustrated in FIG. 10, the wireless device 100 in accordance with Embodiment 6 further includes, in addition to the configuration illustrated in FIG. 1, (i) an antenna member 15 that serves as an antenna different from a frame member 1, and (ii) a wireless circuit 2d connected to a feed connection point 17 of the antenna member 15 via a feed connector 16. As the antenna member 15, it is possible to employ any antenna member similar to the foregoing antenna member 11.

With the above configuration, (i) a region between reference electric potential connection points 6a and 6b of the frame member 1 can be caused to serve as a first antenna that serves as a λ/2 system (an antenna that resonates at a λ/2 (λ corresponds to a frequency to be used during communications)) and (ii) the antenna member 15 can be caused to serve as a second antenna that serves as a λ/4 system such as an inverted L antenna (an antenna that resonates at a λ/4 (λ corresponds to a frequency to be used during communications)).

Specifically, the above configuration fulfills the following conditions (1) through (3).

(1) The wireless device 100 has a substantially rectangular shape. A difference between (i) a length L1 of a short side of the substantially rectangular shape and (ii) one-fourth of a wavelength λ (i.e., λ/4) of a frequency to be used by the first and second antennas, is smaller than a difference between (a) a length L2 of a long side of the substantially rectangular shape and (b) one-fourth of the wavelength λ (i.e., λ/4). That is, L1 is closer to λ/4 of the frequency to be used than L2 is.

(2) The feed connection point 16 of the antenna member 15 is nearer to one of two ends of the short side of the substantially rectangular shape than to the other of two ends of the short side of the substantially rectangular shape.

(3) At least one of the reference electric potential connection points 6a and 6b of the frame member 1 is nearer to one of two ends of the short side of the substantially rectangular shape than to the other of two ends of the short side of the substantially rectangular shape.

In such a case, since the antenna member 15 serves as the λ/4 system, a current flowing through a reference electric potential is more likely to flow in a direction in which the short side of the substantially rectangular shape extends (L1 direction). A direction of a main polarized wave of the antenna member 15 matches the L1 direction. Meanwhile, since the frame member 1 serves as the λ/2 system, a current flowing through the reference electric potential is also more likely to flow in a direction in which the long side of the rectangular shape extends (L2 direction). A direction of a main polarized wave of the frame member 1 matches the L2 direction.

This allows respective polarization directions of the frame member 1 and the antenna member 15 to intersect at right angles. As such, it is possible to design an antenna with less mutual interruption (i.e., achieving a small coupling amount, less isolation, and a high antenna gain). Note that it is possible to use a combination of the first antenna and the second antenna as a diversity antenna, by using the first antenna and the second antenna in identical frequency bands.

Note also that it is not necessary to fulfill all of the above conditions (1) through (3), provided that (i) an antenna that serves as the λ/2 system and (ii) an antenna that serves as the λ/4 system can be achieved. Even in a case where not all of the above conditions (1) through (3) are fulfilled, it is still possible to reduce a coupling amount because (i) the antenna that operates in the λ/2 system and (ii) the antenna that operates in the λ/4 system are different in operation mode.

In a case where an antenna resonates at a plurality of frequencies, the above conditions (1) through (3) are not necessarily fulfilled at all of the plurality of frequencies. In such a case, it is possible to reduce the coupling amount, by partially or wholly fulfilling the above conditions (1) through (3) at one of the plurality of frequencies.

Note that, as with Embodiment 1, in the wireless device 100 in accordance with Embodiment 6, regardless of how (i) a divided position of the frame member 1 is set, (ii) the divided number of the frame member 1 is set, (iii) a length of the frame member 1 is set, (iv) a width of the frame member 1 is set, or the like, the antenna characteristic is scarcely affected, as long as such settings are made, on the frame member 1, outside a region between the reference electric potential connection points 6a and 6b. This makes it possible to increase a degree of freedom in design of the frame member 1, without decreasing the antenna characteristic.

### Embodiment 7

The following description will discuss Embodiment 7 of the present invention. For convenience, any member having a function identical to that of a member discussed in the foregoing embodiments will be given an identical reference numeral, and a description thereof will be omitted.

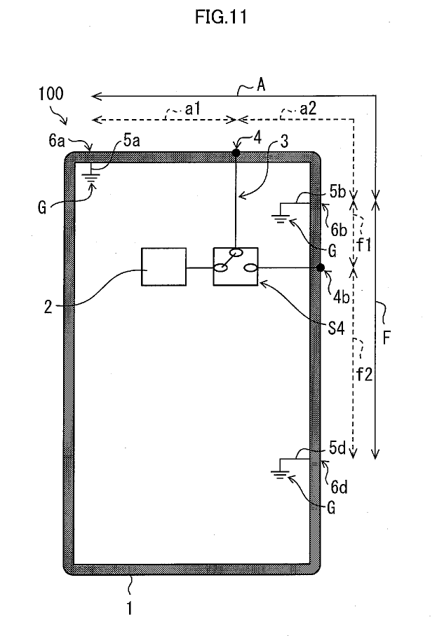

FIG. 11 illustrates a schematic configuration of a wireless device 100 in accordance with Embodiment 7. The wireless device 100 illustrated in FIG. 11 further includes, in addition to the configuration illustrated in FIG. 1, (i) a reference electric potential connector 5d, which connects a reference electric potential connection point (fourth reference electric potential connection point) 6d of a frame member 1 to a reference electric potential G, and (ii) a switch S4 provided in a feed connector 3. The switch S4 switches a connection position of a wireless circuit 2 with respect to the frame member 1, between (i) a feed connection point 4, located between reference electric potential connection points 6a and 6b and (ii) a feed connection point 4b, located between the reference electric potential connection point 6b and a reference electric potential connection point 6d. The switch S4 can be switched by the wireless circuit 2 in accordance with frequencies to be used during respective communications. The switch S4 can alternatively be manually switched by a user.

With the above configuration, in a case where the wireless circuit 2 is connected to the feed connection point 4, as with the configuration illustrated in FIG. 1, current distributions occur in (i) a region (see a region a1 indicated by a dotted line in FIG. 11) between the reference electric potential connection point 6a and the feed connection point 4 and (ii) a region (see a region a2 indicated by a dotted line in FIG. 11) between the feed connection point 4 and the reference electric potential connection point 6b. The two regions (see a region A indicated by a solid line in of FIG. 11) serve as an antenna.

Alternatively, in a case where the wireless circuit 2 is connected to the feed connection point 4b, as illustrated in FIG. 11, current distributions occur in (i) a region (see a region f1 indicated by a dotted line in FIG. 11) between the reference electric potential connection point 6b and the feed connection point 4b and (ii) a region (see a region f2 indicated by a dotted line in FIG. 11) between the feed connection point 4b and the reference electric potential connection point 6d. The two regions (see a region F indicated by a solid line in of FIG. 11) serve as an antenna.

As described above, the wireless device 100 in accordance with Embodiment 7 changes a resonance frequency of the frame member 1, by switching a connection position at which the frame member 1 is connected to the wireless circuit 2. This makes it possible to make communications with the use of various frequencies.

Note that a sensor (not illustrated) that detects a contact position of a user with respect to the frame member 1 can be alternatively further included. With such an alternative, in accordance with a result detected by the sensor, the wireless circuit 2 is configured to switch the switch S4 so that one of (i) a region (see the region a1 of FIG. 11) between the reference electric potential connection points 6a and 6b and (ii) a region between the reference electric potential connection points 6b and 6d, which one region is not contacted by the user, is caused to serve as an antenna. Alternatively, the wireless circuit 2 can be configured to switch the switch S4 in accordance with an RF received power.

Note that, as with Embodiment 1, in Embodiment 7 of the present invention, regardless of how (i) a divided position of the frame member 1 is set, (ii) the divided number of the frame member 1 is set, (iii) a length of the frame member 1 is set, (iv) a width of the frame member 1 is set, or the like, the antenna characteristic is scarcely affected, as long as such settings are made, on the frame member 1, outside a region between the reference electric potential connection points 6a and 6d. This makes it possible to increase a degree of freedom in design of the frame member 1, without decreasing the antenna characteristic.

Note that Embodiment 7 discusses a configuration in which a connection point, at which the wireless circuit 2 is connected to the frame member 1, is switched in the region between the feed connection points 4 and 4b. However, the connection point is not limited as such. Specifically, the connection point can alternatively be switched between three or more connection points.

[Main Points]

A wireless device 100 of a first aspect of the present invention includes: a frame member 1 that is electrically conductive and is provided along a periphery of a housing; and a wireless circuit 2 that makes a wireless communication by using the frame member 1 as an antenna, the frame member 1 having (i) a first reference electric potential connection point 6a and (ii) a second reference electric potential connection point 6b, each of which is connected to a reference electric potential G of the housing, the wireless circuit 2 being connected to a feed connection point 4 that is located between the first reference electric potential connection point 6a and the second reference electric potential connection point 6b.

With the above configuration, a region between the first and second reference electric potential connection points 6a and 6b of the frame member 1 serves as an antenna, and an outside of this region on the frame member 1 scarcely affects an antenna characteristic. That is, regardless of how (i) a divided position of the frame member 1 is set, (ii) the divided number of the frame member 1 is set, (iii) a length of the frame member 1 is set, (iv) a width of the frame member 1 is set, or the like, the antenna characteristic does not decrease, as long as such settings are made, on the frame member 1, outside the above region. This makes it possible to increase a degree of freedom in design of the frame member 1 that is caused to serve as an antenna, without decreasing the antenna characteristic.

In a second aspect of the present invention, the wireless device 100 further includes, in the first aspect of the present invention, a switch S1, the frame member 1 further having a third reference electric potential connection point 6c that is connected, via the switch S1 that is capable of switching between a conductive state and a blocking state, to the reference electric potential G of the housing, the third reference electric potential connection point 6c being located in at least one of (i) a region between the first reference electric potential connection point 6a and the feed connection point 4 and (ii) a region between the feed connection point 4 and the second reference electric potential connection point 6b.

With the above configuration, it is possible to change an antenna characteristic of the frame member 1 by switching the switch S1 between a conductive state and a non-conductive state. This makes it possible to make communications with use of various frequencies.

In a third aspect of the present invention, the wireless device 100 further includes, in the first or second aspect of the present invention, a second switch S2 provided at least one of (i) between the first reference electric potential connection point 6a and the reference electric potential G and (ii) between the second reference electric potential connection point 6a and the reference electric potential G, the second switch S2 switching a connection path, which connects (i) the reference electric potential G to (ii) the first reference electric potential connection point 6a or the second reference electric potential connection point 6b, to one of a plurality of connection paths having respective different impedances.

With the above configuration, it is possible to change the antenna characteristic of the frame member 1, by switching the second switch S2. This makes it possible to make communications with use of various frequencies.

In a fourth aspect of the present invention, the wireless device 100 further includes, in any one of the first to third aspects of the present invention, a plurality of wireless circuits 2, 2b, and 2c that use the frame member as their respective antennas, the plurality of wireless circuits 2, 2b, and 2c being connected to the frame member 1 at respective different positions.

The above configuration allows the wireless circuits 2, 2b, and 2c to make communications with use of respective different frequencies.

In a fifth aspect of the present invention, the wireless device 100 is arranged such that, in the fourth aspect of the present invention, (i) the frame member 1 further has a fourth reference electric potential connection point 6d, located outside a region between the first and second reference electric potential connection points 6a and 6b, which is connected to the reference electric potential G of the housing, (ii) parts (wireless circuits 2 and 2b) of the plurality of wireless circuits 2, 2b, and 2c are connected to the respective feed connection points 4 and 4b, which are located between the first and second reference electric potential connection points 6a and 6b of the frame member 1, respectively, and (iii) another part (wireless circuit 2c) of the plurality of wireless circuits 2, 2b, 2c, and 2d is connected to a feed connection point 4c located between the first and fourth reference electric potential connection points 6a and 6d or between the second and fourth reference electric potential connection points 6b and 6d.

With the above configuration, the wireless circuits 2, 2b, and 2c can make communications with use of respective different frequencies.

In a sixth aspect of the present invention, the wireless device 100 is arranged such that, in any one of the first to fifth aspects of the present invention, the wireless circuit 3 is connected to the feed connection point 4 via an antenna member 11 that serves as an antenna. Note that the antenna member 11 can be separately provided from the frame member 1, and can alternatively be configured to be integrated with the frame member 1.

The above configuration allows an increase in the number of current paths that serve as antennas. This makes it possible to make communications with use of various frequencies.

In a seventh aspect of the present invention, the wireless device 100 further includes, in any one of the first to sixth aspects of the present invention, a capacitor connection point 14 that is connected, via a capacitive element 12, to the reference electric potential G of the housing, the capacitor connection point 12 being located (i) between the first reference electric potential connection point 6a and the feed connection point 4 or (ii) between the feed connection point 4 and the second reference electric potential connection point 6b.

With the above configuration, it is possible to adjust the antenna characteristic of the frame member 1 by using the capacitive element 12. In such a case, it is possible to set positions of (i.e., a spacing between) the respective first and second reference electric potential connection points 6a and 6b of the frame member 1, which positions (spacing) are to be used for making communications at a given frequency, to be different in a case where the capacitive element 12 is not provided. This makes it possible to further increase the degree of freedom in design of the frame member 1.

In an eighth aspect of the present invention, the wireless device 100 further includes, in any one of the first to seventh aspects of the present invention, (i) an antenna member 15, connected between the wireless circuit 2 and the feed connection point 4, that serves as an antenna, and (ii) a wireless circuit 2d, connected to the antenna member 15, that makes a wireless communication by using the antenna member 15 as an antenna.

The above configuration allows an increase in the number of current paths that serve as antennas. This makes it possible to make communications with use of various frequencies.

In a ninth aspect of the present invention, the wireless device 100 is arranged such that, in any one of the first to eighth aspects of the present invention, (i) the frame member 1 further has a fourth reference electric potential connection point 6d, located outside a region between the first and second reference electric potential connection points 6a and 6d and connected to the reference electric potential G of the housing, (ii) the wireless circuit 2 is connected, via a switch S4, to (a) the feed connection point 4 and to (b) a feed connection point 4b located between the first and fourth reference electric potential connection points 6a and 6d or between the second and fourth reference electric potential connection points 6b and 6d, and (iii) the switch S4 electrically connects the wireless circuit 2 to the feed connection point 4 and switches between a first state, where the wireless circuit 2 and the feed connection point 4 are electrically connected and the wireless circuit 2 and the feed connection point 4b are electrically disconnected, and a second state, where the wireless circuit 2 and the feed connection point 4 are electrically disconnected and the wireless circuit 2 and the feed connection point 4b are electrically connected.

With the above configuration, it is possible to switch, by using the switch S4, a region of the frame member 1 which region serves as an antenna. This makes it possible to make communications with use of various frequencies.

The present invention is not limited to the embodiments above, but can be altered by a skilled person in the art within the scope of the claims. That is, an embodiment based on a proper combination of technical means disclosed in different embodiments is encompassed in the technical scope of the present invention.

### INDUSTRIAL APPLICABILITY

The present invention is applicable to a wireless device whose frame member, made of an electrically conductive material and provided along a periphery of a housing, is caused to serves as an antenna.

### REFERENCE SIGNS LIST

1 Frame member (electrically conductive frame member, metal frame member)
2, 2b, 2c, 2d Wireless circuit
3, 3b, 3c Feed connector
4, 4b, 4c Feed wiring point
5a through 5d Reference electric potential connector
6a Reference electric potential connection point (first reference electric potential connection point)
6b Reference electric potential connection point (second reference electric potential connection point)
6c Reference electric potential connection point (third reference electric potential connection point)
6d Reference electric potential connection point (fourth reference electric potential connection point)
7, 7b, 7c, 8, 9a, 9b Antenna constant matching section
11, 13, 15 Antenna
12 Capacitive element
14 Capacitor connection point
16 Feed connector
17 Feed connection point
100 Wireless device
G Reference electric potential
S1, S3, S4 Switch
S2 Switch (second switch)

1-5. (canceled)

6. A wireless device, comprising:
a frame member that is electrically conductive and is provided along a periphery of a housing; and
a first wireless circuit that makes a wireless communication by using the frame member as an antenna,
the frame member having (i) a first reference electric potential connection point and (ii) a second reference electric potential connection point, each of which is connected to a reference electric potential of the housing,
the first wireless circuit being connected to a first feed connection point that is located between the first reference electric potential connection point and the second reference electric potential connection point;
a first antenna member that serves as an antenna different from the frame member; and
a second wireless circuit that is connected to a second feed connection point located on the first antenna member,
in a case where a wavelength corresponding to a frequency that the wireless device uses for making a wireless communication is indicated by λ, the frame member serving as a λ/2 system and the first antenna member serving as a λ/4 system.

7. A wireless device as set forth in claim 6, wherein:
the frame member has a rectangular shape, a length of a short side of the rectangular shape being indicated by L1 and a length of a long side of the rectangular shape being indicated by L2; and
a difference between L1 and λ/4 is smaller than a difference between L2 and λ/4.

8. A wireless device as set forth in claim 7, wherein:
the second feed connection point is located so as to be nearer to one of two ends of the short side of the frame member.

9. A wireless device, comprising:
a frame member that is electrically conductive and is provided along a periphery of a housing; and
a plurality of first wireless circuits each making a wireless communication by using the frame member as an antenna,
the frame member having (i) a first reference electric potential connection point and (ii) a second reference electric potential connection point, each of which is connected to a reference electric potential of the housing,
the plurality of first wireless circuits being independently connected to respective of a plurality of first feed connection points that are located at respective different positions between the first reference electric potential connection point and the second reference electric potential connection point.

10. A wireless device as set forth in claim 9, wherein
the frame member has a third reference electric potential connection point, located outside a region between the first reference electric potential connection point and the second reference electric potential connection point, which is connected to the reference electric potential of the housing;
part of the plurality of first wireless circuits is/are connected to the first feed connection point located between the first reference electric potential connection point and the second reference electric potential connection point; and
another part of the plurality of first wireless circuits is/are connected to a third feed connection point, located between the first reference electric potential connection point and the third reference electric potential connection point or between the second reference electric potential connection point and the third reference electric potential connection point.

11. A wireless device as set forth in claim 6, further comprising:
a first switch,
the frame member further having a fourth reference electric potential connection point that is connected, via the first switch that is capable of switching between a conductive state and a blocking state, to the reference electric potential of the housing,
the third reference electric potential connection point being located in at least one of (i) a region between the first reference electric potential connection point and the first feed connection point and (ii) a region between the first feed connection point and the second reference electric potential connection point.

12. A wireless device as set forth in claim 6, further comprising:
a second switch provided at least one of (i) between the first reference electric potential connection point and the reference electric potential and (ii) between the second reference electric potential connection point and the reference electric potential,
the second switch switching a connection path, which connects (i) the reference electric potential to (ii) the first reference electric potential connection point or the second reference electric potential connection point, to one of a plurality of connection paths having respective different impedances.

13. A wireless device as set forth in claim 6, wherein:
the first wireless circuit is connected to the first feed connection point via a second antenna member that serves as an antenna.

14. A wireless device as set forth in claim 9, further comprising:
a first switch,
the frame member further having a fourth reference electric potential connection point that is connected, via the first switch that is capable of switching between a conductive state and a blocking state, to the reference electric potential of the housing,
the third reference electric potential connection point being located in at least one of (i) a region between the first reference electric potential connection point and the first feed connection point and (ii) a region between the first feed connection point and the second reference electric potential connection point.

15. A wireless device as set forth in claim 9, further comprising:
a second switch provided at least one of (i) between the first reference electric potential connection point and the reference electric potential and (ii) between the second reference electric potential connection point and the reference electric potential,
the second switch switching a connection path, which connects (i) the reference electric potential to (ii) the first reference electric potential connection point or the second reference electric potential connection point, to one of a plurality of connection paths having respective different impedances.

16. A wireless device as set forth in claim 9, wherein:
the first wireless circuit is connected to the first feed connection point via a second antenna member that serves as an antenna.
